(19) United States
(12) Patent Application Publication
(10) Pub. No.: US 2009/0152319 A1
(43) Pub. Date: Jun. 18, 2009

(54) Pneumatic tool design

(75) Inventors: William Carlos Cain, Irmo, SC (US); Richard Marcus Mansfield, Lexington, SC (US)

Correspondence Address: KING & SPALDING, 1180 PEACHTREE STREET , NE, ATLANTA, GA, 30309-3521, US

(73) Assignee: Cooper Brands, Inc.

(21) Appl. No.: 12/001,525

(22) Filed: Dec. 12, 2007

(51) Int. Cl. B25C 1/04; B25B 13/00; B24B 21/00

(52) U.S. Cl. 227/130; 173/218; 81/57.44; 451/296

(57) ABSTRACT

An improved pneumatic tool design includes pneumatic motor chamber that houses a turbine. An air path directs compressed air into the pneumatic motor chamber. The air path includes an air inlet chamber that at least partially surrounds the pneumatic motor chamber. The air path also includes a motor inlet disposed in one side wall (e.g., the top wall) of the pneumatic motor chamber forward of the rear end plate thereof. The air path further includes at least one exhaust port disposed in an opposite side wall (e.g., the bottom wall) of the pneumatic motor chamber. A high-pressure seal, such as an o-ring, surrounds the pneumatic motor chamber and isolates the motor inlet, which is thus at a rear outer portion of the pneumatic motor chamber, from a forward outer portion of the pneumatic motor chamber.

### FIELD OF THE INVENTION

The present invention relates generally to compact or handheld pneumatic tools. More particularly described, the present invention relates to an improved pneumatic tool design for generating increased power and improved performance.

### BACKGROUND OF THE INVENTION

Pneumatic tools, or air tools, are typically powered by gas, such as compressed air or compressed carbon dioxide. A compact “pistol grip” pneumatic tool configuration generally resembles the shape of a pistol. That is, a pistol grip pneumatic tool includes a handle that is generally perpendicular to the tool head and a trigger mechanism disposed on the handle. Common pistol grip pneumatic tools include handheld drills, sanders, nail guns, nut runners, etc. A compact “inline” pneumatic tool configuration generally includes a handle that is parallel to the tool head, with a trigger mechanism disposed on the handle. Common inline pneumatic tools include drills, grinders, nut runners, etc.

In a conventional pneumatic tool design, compressed air is forced into a pneumatic motor chamber, causing a turbine therein to spin and power a drive shaft, plunger or other actuator. However, in conventional pneumatic tool designs, the motor inlet that allows compressed air to enter the pneumatic motor chamber is disposed in an end plate at the rear of the pneumatic motor chamber. This location is a limiting factor in the size of the motor inlet. In particular, if the motor inlet is too large or too small, the compressed air will not properly engage the turbine inside the pneumatic motor chamber. Further, because the air inlet chamber which leads to the motor inlet is positioned behind the end plate of the pneumatic motor chamber in the conventional design, the size of the pneumatic motor chamber is necessarily limited by the form factor of the tool. To accommodate a larger pneumatic motor, the overall size of the tool would need to be increased. Accordingly, there exists a need in the art for a pneumatic tool design that allows a greater variation in the size of the motor inlet through which compressed enters the pneumatic motor. Further, there exists a need in the art for a pneumatic tool that maximizes the size of the pneumatic motor chamber without increasing the overall size of the pneumatic tool.

### SUMMARY OF THE EXEMPLARY EMBODIMENTS

The present invention meets the aforementioned need in the art by providing an improved pneumatic tool design. The pneumatic tool design may be applied to a pistol grip or inline pneumatic tool. The improved design includes a pneumatic motor chamber for housing a turbine. The pneumatic motor chamber has at least a first side wall, a second side wall and a rear end plate. The improved design includes an air path for directing compressed air into and through the pneumatic motor chamber. The air path includes an air inlet chamber that at least partially surrounds the pneumatic motor chamber, a motor inlet disposed in the first side wall of the pneumatic motor chamber and at least one exhaust port disposed in the second side wall of the pneumatic motor chamber. For example, the motor inlet may be disposed in the top wall of the pneumatic motor chamber and the exhaust port may be disposed in the bottom wall of the pneumatic motor chamber. Alternatively, the motor inlet may be disposed in the bottom wall of the pneumatic motor chamber and the exhaust port may be disposed in the top wall of the pneumatic motor chamber. A seal surrounds the pneumatic motor chamber and isolates the motor inlet, which is thus at a rear outer portion of the pneumatic chamber, from a forward outer portion of the pneumatic motor chamber. The seal may be, for example, an o-ring or another suitable sealing member.

### BRIEF DESCRIPTION OF THE DRAWINGS

FIG. 1 is a side profile cross-sectional view of a conventional pneumatic tool.

FIG. 2 is a side profile cross-sectional view of a pneumatic tool according to certain exemplary embodiments of the present invention.

FIG. 3 is a rear profile cross-sectional view of a pneumatic tool according to certain exemplary embodiments of the present invention.

### DETAILED DESCRIPTION OF THE EXEMPLARY EMBODIMENTS

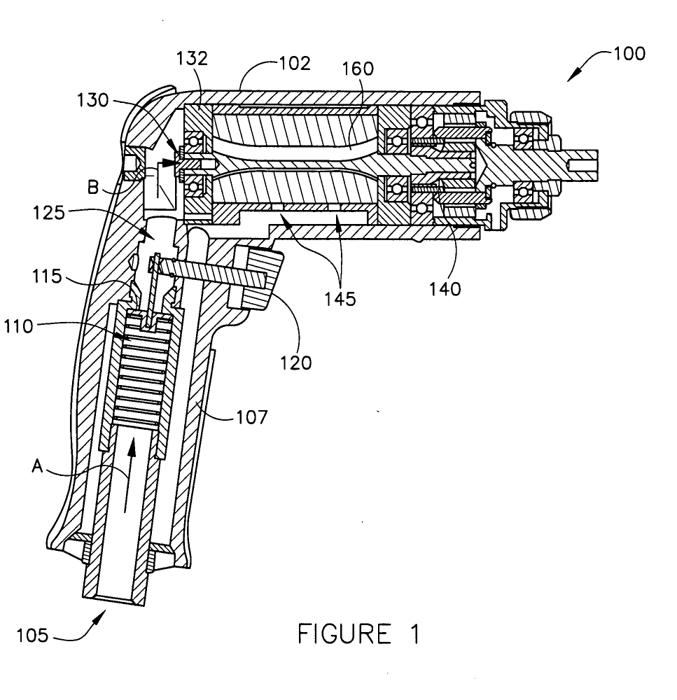

The present invention provides an improved pneumatic tool design, which includes an air path that at least partially surrounds the circumference of a rear outer portion of a pneumatic motor chamber. This air path is separated from a forward outer portion of the pneumatic motor chamber by a seal. The air path includes a motor inlet that may be positioned along the top, bottom or a side of the pneumatic motor chamber between the high-pressure seal and the rear end plate of the pneumatic motor chamber. According to the inventive design, the size of the motor inlet can be larger than in conventional pneumatic tool designs. Furthermore, because the motor inlet is not positioned behind the pneumatic motor chamber, the size of the pneumatic motor chamber can be increased without substantially increasing the overall dimensions of the pneumatic tool. Referring to the drawings, in which like numerals represent like elements throughout the several figures, aspects of the present invention will be described in the context of FIGS. 1-3.

FIG. 1 is a side profile cross-sectional view of a conventional pistol grip pneumatic tool, such as a handheld drill 100. As illustrated, the pneumatic drill 100 has a housing 102, wherein an air inlet 105 is disposed at the base of a handle 107. The air inlet 105 receives compressed air (or other gas) from an air compressor or other suitable input device. The compressed air enters an inlet flume 110 and flows in the path indicated by the arrow A. A trigger valve 115, when closed, prevents the compressed air from entering an air inlet chamber 125. The trigger valve 115 is controlled by a trigger mechanism 120 disposed on the handle 107. When the trigger mechanism 120 is engaged, the trigger valve 115 is forced in the direction opposite of the arrow A, thus allowing the compressed air to pass the trigger valve 115 and enter an air inlet chamber 125.

The air inlet chamber 125 extends up the inside of the handle 107 behind a pneumatic motor chamber 135. After the compressed air enters the inlet chamber 125, according to FIG. 1, it makes a roughly 90° turn to enter the pneumatic motor chamber 135 through a motor inlet 130 positioned in the end plate 132 of the pneumatic motor chamber 135. This bend in the air path towards the motor inlet 130 is illustrated by arrow B. After passing into the pneumatic motor chamber 135, the compressed air engages a turbine 160 located therein and causes it to spin. This, in turn, powers a drive shaft 140. Once completed, the air escapes out of the pneumatic motor 135 through one or more exhaust ports 145.

Accordingly, as illustrated in FIG. 1, a conventional pneumatic tool design 100 includes a motor inlet 130 that is located on the end plate 132 of the pneumatic motor chamber 135 and an inlet chamber 125 that is positioned behind the pneumatic motor chamber 135. The size of the motor inlet 130 (and, hence, the volume of air that can enter the pneumatic motor chamber 135) is thus constrained by certain factors. Specifically, if the motor inlet 130 is sized too small, the compressed air entering the pneumatic motor chamber 135 will not sufficiently engage the turbine 160. And, notably, if it is sized too large or positioned incorrectly, the compressed air entering the pneumatic motor chamber 135 may bypass the turbine 160 and escape through the one or more exhaust ports 145. Thus, in a conventional pneumatic tool design 100, simply enlarging the size of the motor inlet 130 may in fact result in a reduction of horsepower and performance.

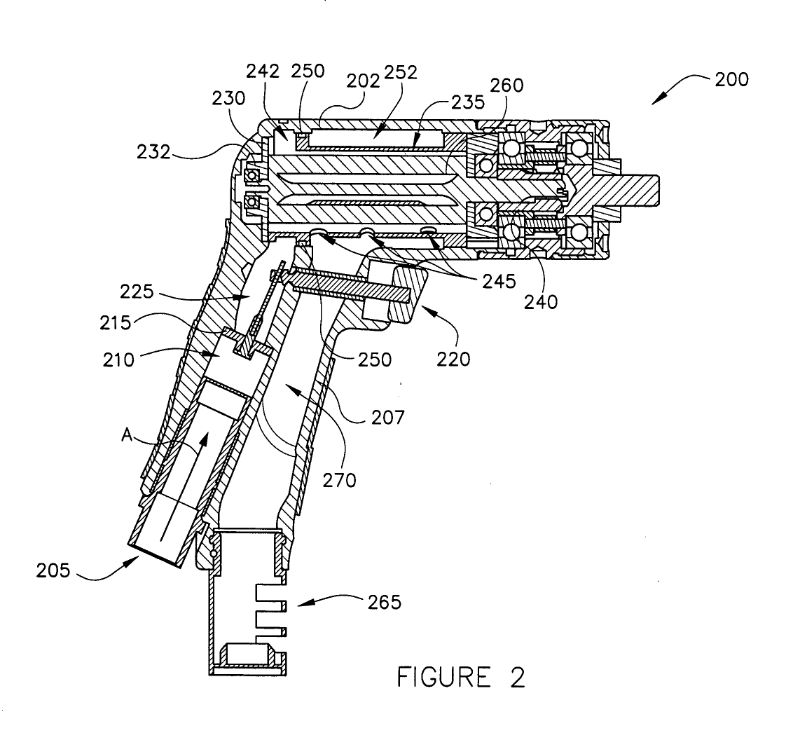

FIG. 2 illustrates a side profile cross-sectional view of an improved pneumatic tool design 200, according to certain exemplary embodiments of the present invention. While the description of exemplary embodiments refers to a pneumatic drill, one of ordinary skill in the art will understand that the design of the present invention may be applied to other types of pistol grip and inline pneumatic tools, including, but not limited to, nut runners, grinders, nail guns, sanders, etc. The embodiment shown in FIG. 2 is a pistol grip pneumatic tool design, which includes an upper tool housing 202 and a handle 207 disposed somewhat perpendicular to the upper tool housing 202. Compressed air enters an air inlet 205 at the base of the handle 207, travels along the path indicated by arrow A, and enters an air flume 210. A trigger valve 215, when closed, prevents the compressed air from entering an air inlet chamber 225. The trigger valve 215 is controlled by a trigger mechanism 220 disposed on the handle 207. When the trigger mechanism 220 is engaged, the trigger valve 215 is forced in the direction opposite of the arrow A, thus allowing the compressed air to pass the trigger valve 215 and enter the air inlet chamber 225.

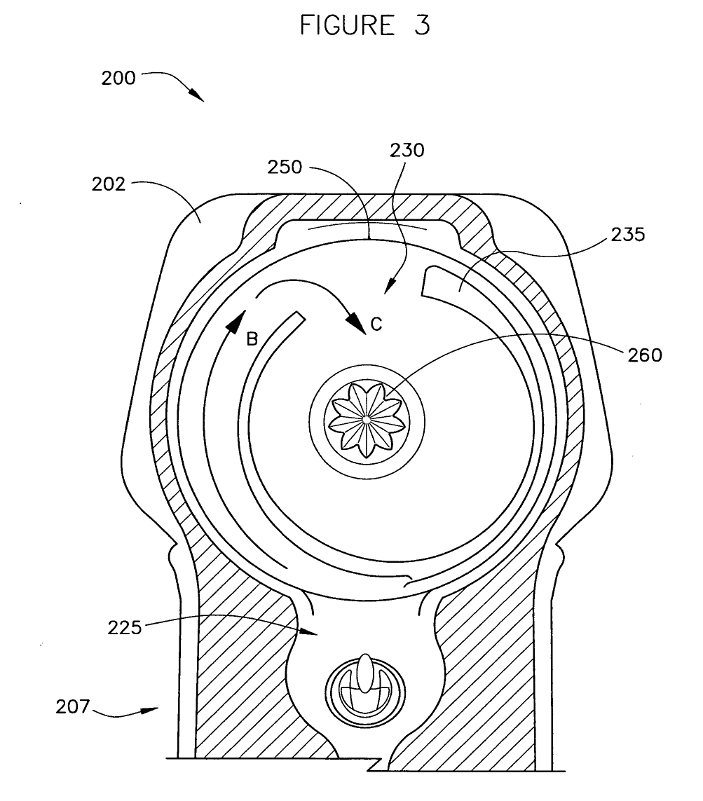

As shown in FIG. 3, which is a rear profile cross-sectional view of the improved pneumatic tool design 200, the air inlet chamber 225 extends around the outside circumference of the pneumatic motor chamber 235. In the illustrated embodiment, one side of the portion of the air inlet chamber 225 that extends around the pneumatic motor chamber 235 is wider than the other. As a result, the wider side will be the primary air path, as illustrated by arrow B. The compressed air enters into the pneumatic motor chamber 235 through the motor inlet 230, as illustrated by arrow C. In certain embodiments, the air inlet chamber 225 may be configured to extend only partially around the outside circumference of the pneumatic motor chamber 235 (e.g., around one side thereof). Alternatively, each side of the air inlet chamber 225 extending around the pneumatic motor chamber 235 may be of substantially equal width.

As illustrated in FIG. 2, a seal 250 isolates a rear outer portion 242 of the pneumatic motor chamber 235 from a forward outer portion 252 of the pneumatic motor chamber 235. Again, the rear outer portion 242 of the pneumatic motor chamber 235 includes the motor inlet 230. The seal 250 may be an o-ring or any other sealing mechanism that is suitable for sealing a shaft and withstanding the pressure (e.g., 90 psi) of the compressed air. In certain embodiments, the rear outer portion 242 and/or the forward outer portion 252 of the pneumatic motor chamber 235 may be machined in such a way as to provide a mechanical seal therebetween, thus eliminating the need for the seal 250.

Once the compressed air enters the pneumatic motor chamber 235, it spins a turbine 260, which in turn powers a drive shaft 240. The drive shaft 240 actuates a tool head, such as a drill bit or a nut runner. In other types of power tools, the turbine 260 may be used to power other types of actuators. For example, the turbine 260 may power a means for rotating a sanding belt in a pneumatic sander or a plunger for driving a nail in a pneumatic nail gun. In the illustrated exemplary embodiment, the motor inlet 230 is located in the top wall of the pneumatic motor chamber 235 between the end plate 232 and the seal 250. In alternative embodiments, however, the motor inlet 230 may be disposed in the bottom wall or a different side wall of the pneumatic motor chamber 235 between the end plate 232 and the seal 250. In embodiments where the motor inlet 230 is disposed in the bottom wall of the pneumatic motor chamber 235, an additional improvement in power and performance may be achieved by confining the compressed air flow to a substantially linear path prior to its entering the pneumatic motor chamber 235.

Extending the air inlet chamber 225 around the side of the pneumatic motor chamber 235 and positioning the motor inlet 230 on the top (or bottom or side) wall thereof, allows the motor inlet 230 to be larger than in a conventional pneumatic tool design 100. Specifically, the direction of the air flow and the curved portion of the air inlet chamber 125 provide a rotational bias to the compressed air as it enters the motor inlet 230, thereby causing the compressed air to properly engage the turbine 260, even when the size of the motor inlet 230 is increased. Increasing the volume of air entering the pneumatic motor chamber 235 can result in increased horsepower generated by the pneumatic motor. Further, because the motor inlet 230 is disposed on the top (or bottom or side) wall of the pneumatic motor chamber 235—as opposed to behind the rear end plate 232—the pneumatic motor chamber 235 can be extended lengthwise without increasing the length of the upper tool housing 202 or the overall dimensions of the tool. This increase in size of the pneumatic motor chamber 235 can accommodate a larger pneumatic motor capable of generating increased horsepower. Further, in the event the pneumatic motor chamber 235 is not lengthened, the length of the upper tool housing 202 (and thus the overall dimensions of the tool) can be reduced without a loss of horsepower.

As illustrated in FIG. 2, after engaging the turbine 260, compressed air exits the pneumatic motor chamber 235 through one or more exhaust ports 245. As discussed, the seal 250 isolates a rear outer portion 242 of the pneumatic motor chamber 235 from a forward outer portion 252 thereof. In this way, the motor inlet 230 is also isolated from the exhaust ports 245, such that the compressed air is prevented from escaping to the exhaust ports 245 before it enters the pneumatic motor chamber 235. In the illustrated embodiment, the motor inlet 230 is located in the top wall of the pneumatic motor chamber 235 and the exhaust ports 245 are located in the bottom wall of the pneumatic motor chamber 235. This arrangement provides sufficient space for the compressed air to expand within the pneumatic motor chamber 235. Accordingly, in embodiments where the motor inlet 230 is located in the bottom wall of the pneumatic motor chamber 235, the exhaust ports 245 may be located in the top wall thereof. In other embodiments, the exhaust ports 245 may be positioned in the top or the sides of the pneumatic motor chamber 235, so long as there is sufficient spacing between them and the motor inlet 230. In the illustrated embodiment, the exhaust ports 245 lead to a muffler 265 located at the base of the handle 207. In alternative embodiments, the muffler 265 can be positioned on the top or a side of the upper housing 202, or at other locations on the pneumatic tool.

The improved pneumatic tool design 200 of the present invention provides superior performance over a conventional pneumatic tool design 100. In particular, the improved pneumatic tool design 200 can accommodate a larger motor inlet 230, which allows a greater volume of compressed air to engage the turbines 260 that power the tool. Further, the improved pneumatic tool design 200 can accommodate a larger pneumatic motor chamber 235 without requiring a change to the overall form factor of the tool. By way of example, the horsepower generated by two commercially-available pistol grip pneumatic power drills, the ATLAS COPCO LBB36 and the DOTCO 14CNL, was compared to the horsepower generated by a pneumatic power drill according to the present invention. For purposes of the comparison, the pistol grip pneumatic power drill according to the present invention was designed with substantially the same overall dimensions as the commercially-available pneumatic power drills, and all three tools were connected to the same air compressor. However, the inventive pistol grip pneumatic power drill design was able to accommodate a larger, more powerful motor. The results of the comparison are presented in Table 1 below, which shows that the inventive pneumatic drill exhibited a substantial increase in horsepower over the two conventional pneumatic drills of approximately the same size. In fact, the inventive pneumatic drill generated almost double the horsepower of the conventional tools.

TABLE 1

| Model | Horsepower Generated |
|---|---|
| ATLAS COPCO LBB36 | 0.84 |
| DOTCO 14CNL | 0.80 |
| Inventive Pistol Grip Pneumatic Drill | 1.44 |

Based on the foregoing, it will be understood that the improved pneumatic tool design of the present invention offers many advantages over conventional pneumatic tool designs. While certain exemplary embodiments of the present invention have been shown and described herein, it will be evident to those of ordinary skill in the art that various modifications and changes may be made thereto without departing from the spirit and the scope of the present invention as set forth herein. It should be appreciated, therefore, that aspects of the present invention were described above by way of example only and are not intended as required or essential elements of the invention unless explicitly stated otherwise.

What is claimed is:

1. An improved pneumatic tool, comprising:
a pneumatic motor chamber housing a turbine;
an air path comprising an air inlet chamber at least partially surrounding the pneumatic motor chamber and a motor inlet disposed in a rear outer portion of the pneumatic motor chamber, wherein said rear outer portion is forward of a rear end plate of the pneumatic motor chamber; and
a seal surrounding the pneumatic motor chamber and isolating the rear outer portion thereof from a forward outer portion thereof.

2. The improved pneumatic tool of claim 1, further comprising at least one exhaust port disposed on a side of the pneumatic motor chamber opposite of the motor inlet.

3. The improved pneumatic tool of claim 1, wherein the rear outer portion of the pneumatic motor chamber comprises the top of the pneumatic motor chamber.

4. The improved pneumatic tool of claim 1, wherein the rear outer portion of the pneumatic motor chamber comprises the bottom of the pneumatic motor chamber.

5. The improved pneumatic tool of claim 1, wherein the turbine powers a drive shaft for rotating a tool head.

6. The improved pneumatic tool of claim 5, wherein the tool head comprises a drill bit or a nut runner.

7. The improved pneumatic tool of claim 1, wherein the turbine powers a means for rotating a sanding belt.

8. The improved pneumatic tool of claim 1, wherein the turbine powers a plunger for driving a nail.

9. The improved pneumatic tool of claim 1, wherein the seal comprises an o-ring.

10. The improved pneumatic tool of claim 1, wherein the seal comprises a mechanical seal.

11. A improved pneumatic tool, comprising:
a pneumatic motor chamber housing a turbine, said pneumatic motor chamber having a first side wall, a second side wall and a rear end plate;
an air path comprising an air inlet chamber at least partially surrounding the pneumatic motor chamber, a motor inlet disposed in the first side wall of the pneumatic motor chamber and at least one exhaust port disposed in the second side wall of the pneumatic motor chamber; and
a seal surrounding the pneumatic motor chamber and isolating the motor inlet from a forward outer portion of the pneumatic motor chamber.

12. The improved pneumatic tool of claim 11, wherein the turbine powers a drive shaft connected to a tool head.

13. The improved pneumatic tool of claim 12, wherein the tool head comprises a drill bit or a nut runner.

14. The improved pneumatic tool of claim 11, wherein the turbine powers a means for rotating a sanding belt.

15. The improved pneumatic tool of claim 11, wherein the turbine powers a plunger for driving a nail.

16. The improved pneumatic tool of claim 11, wherein the seal comprises an o-ring.

17. The improved pneumatic tool of claim 11, wherein the seal comprises a mechanical seal.

18. The improved pneumatic tool of claim 11, wherein the first side wall of the pneumatic motor chamber comprises the top of the pneumatic motor chamber; and
wherein the second side wall of the pneumatic motor chamber comprises the bottom of the pneumatic motor chamber.

19. The improved pneumatic tool of claim 11, wherein the first side wall of the pneumatic motor chamber comprises the bottom of the pneumatic motor chamber; and
wherein the second side wall of the pneumatic motor chamber comprises the top of the pneumatic motor chamber.
